(19) United States
(12) Patent Application Publication
(10) Pub. No.: US 2018/0366695 A1
(43) Pub. Date: Dec. 20, 2018

(54) BATTERY ASSEMBLY

(71) Applicant: HUIZHOU KIMREE TECHNOLOGY CO., LTD. SHENZHEN BRANCH, Shenzhen, Guangdong (CN)

(72) Inventors: Qiuming Liu, Shenzhen, Guangdong (CN); Zhiyong Xiang, Dongguan, Guangdong (CN); Zhilin Wei, Shenzhen, Guangdong (CN); Jianhua Niu, Shenzhen, Guangdong (CN)

(21) Appl. No.: 16/062,893

(22) PCT Filed: Dec. 15, 2015
(86) PCT No.: PCT/CN2015/097512

§ 371 Date: Jun. 15, 2018

(51) Int. Cl. H01M 2/10; A24F 47/00; H05B 1/02; H01M 2/26; H01M 2/24; H01M 2/04; H01M 2/02

(52) U.S. Cl. CPC H01M 2/1055; A24F 47/008; H05B 1/0297; H01M 2/022; H01M 2/24; H01M 2/0404; H01M 2/26

(57) ABSTRACT

A battery assembly comprises a battery case, a battery defined in the battery case, and a connection assembly for being connected to an atomization assembly; the battery assembly further comprises: a first connection member, a second connection member, a potentiometer, and a temperature control adjustment valve; the temperature control adjustment valve is movably sleeved on a connection arm for connecting the first connection member and the second connection member and is rotatable relative to the connection arm; the potentiometer is electrically connected to the connection assembly; electric potential of the potentiometer can be adjusted by rotating the temperature control adjustment valve, in order to adjust the power supply from the battery to the atomization assembly, and then temperature of a heating wire in the atomization assembly is adjusted. The battery assembly is capable of adjusting the temperature of the heating wire, simple and compact in structure, and convenient to operate.

### FIELD OF THE INVENTION

The present application relates to the technical field of an electronic cigarette, and more particularly, relates to a battery assembly.

### BACKGROUND OF THE INVENTION

Electronic cigarette is a common electronic product of cigarette simulation, which is mainly used for quitting smoking and replacing cigarettes. The structure of an electronic cigarette comprises a battery assembly and an atomization assembly. When a user's smoking action is detected, the battery assembly is powered by the atomization assembly, making the atomization assembly get into working state. When the atomization assembly is working, a heating wire will generate heat, and then e-liquid is evaporated and atomized by heat, forming gas mist that simulates smoke, therefore, the user has a similar feeling of real smoking when using an electronic cigarette.

At present, the battery assembly of electronic cigarette comprises a battery, electronic wires, a PCBA (Printed Circuit Board Assembly) board, electrodes, buttons and so on. The battery is connected to the electrodes and supplies power to the atomization assembly by the electrode. The battery also connects to the PCBA board via the electronic wires, and the PCBA board integrates control and management functions of the battery assembly, comprising battery short circuit protection, battery charging protection, management button operation and so on. The battery assembly simply supplies power for the atomization assembly to heat and vaporize the e-liquid by the heating wire. However, the e-liquid would only produces the best flavor in an appropriate atomization temperature, if the temperature of the heating wire goes too high or too low, the flavor of smoke atomized by the e-liquid would became bad, moreover, when the temperature of the heating wire is too high to a certain degree, it can cause the dry burning and odor of the heating wire, affecting customer experience.

In order to solve this technical problem, some electronic cigarettes developers set a control knob on the battery assembly to regulate output power of the battery, for a user to adjust the output power from the battery assembly to the atomization assembly, so as to adjust heating temperature of the heating wire of the atomization assembly. However, such existing control knob set in one end of the battery assembly which is opposite to the atomization assembly (or other unreasonable location), is inconvenient for the user's operation.

Therefore, the battery assembly in the existing electronic cigarette cannot adjust the temperature of the heating wire of the electronic cigarette, or the temperature control knob of the battery assembly which is set in an unreasonable location would bring inconvenience to the user.

Aiming at the existing technology problems in the prior art that the battery assembly in the electronic cigarette cannot adjust the temperature of the heating wire of the electronic cigarette, or the temperature control knob of the battery assembly which is set in the unreasonable location would bring inconvenience to the user, the present application provides a battery assembly which could adjust the output power from the battery to the atomization assembly (which could be equivalent to adjust the temperature of the heating wire of the atomization assembly for atomizing the e-liquid), the battery has a simple and compact structure and is easy for the user to adjust the temperature.

### Solutions to the Technical Problem

### Technical Solutions

The present application provides a battery assembly, which is applied for forming an electronic cigarette with an atomization assembly; the battery assembly comprises a battery case, a battery defined in the battery case and a connection assembly for being connected to the atomization assembly; the battery assembly further comprises: a first connection member, a second connection member, a potentiometer and a temperature control adjustment valve.

The battery case comprises a first casing and a second casing, the battery is defined in the first casing, and the connection assembly is inserted in one end of the second casing, the end of the second casing is opposite to the first casing; the first connection member comprises a first connection base inserted in one end of the first casing, a first perforation is defined in a central part of the first connection base; the second connection member comprises a second connection base inserted in one end of the second casing, a second perforation is defined in a central part of the second connection base; a connection arm for connecting the first connection member and the second connection member is formed by an extension of the edge of the first perforation and/or the edge of the second perforation along a longitudinal direction of the battery case.

The temperature control adjustment valve is movably sleeved on the connection arm, and can be rotated relative to the connection arm, the potentiometer is defined on one side of the temperature control adjustment valve which is opposite to the second casing, the potentiometer is electrically connected to the connection assembly; electric potential of the potentiometer can be adjusted by rotating the temperature control adjustment valve to adjust a current supplied from the battery to the atomization assembly, so as to achieve a temperature adjustment of a heating wire in the atomization assembly, the heating wire is applied for atomizing e-liquid.

Appropriately, the connection arm comprises a first extension tube formed by the extension of the edge of the first perforation along the longitudinal direction of the battery case and a second extension tube formed by the extension of the edge of the second perforation along the longitudinal direction of the battery case; the second extension tube sleeves on the first extension tube, and the temperature control adjustment valve is movably sleeved on the second extension tube.

Appropriately, an outer circumference surface of one end of the first connection base is extended outward to form a spacing ring which is in a ring shape, the first connection base is fixedly coupled with the first casing by an interference fit, and the spacing ring is abutted against an end surface of the first casing to block the first connection base from moving to a direction of the battery.

Appropriately, a limiting groove which is in a ring shape is defined on an end surface of the first casing, the spacing ring is embedded in the limiting groove.

Appropriately, the battery comprises a first electrode and a second electrode; a first insulating ring is inserted in the first perforation. A first electrode column is inserted in the first insulating ring, the first electrode column is abutted against the first electrode and electrically connected to the connection assembly by a wire; one end of the first casing is detachably connected to a battery cover assembly, the end of the first casing is opposite to the first connection member, the battery cover assembly is elastically abutted against the second electrode, so that the second electrode is electrically connected to the connection assembly by the battery cover assembly, the first casing, the first connection member and the second connection member.

Appropriately, the connection assembly comprises a hollow connector and a second electrode column defined in a hollow part of the connector; the second electrode column is abutted against a wall of the hollow part of the connector by a second insulating ring and is applied for supplying power to the atomization assembly when the battery assembly is connected to the atomization assembly.

Appropriately, one end of the second connection base is fixed to the connector by a first pin, the end of the second connection base is opposite to the first connection base.

Appropriately, a rotating bracket is interference fitted between the temperature control adjustment valve and the second connection base along a longitudinal direction of the battery assembly, a top surface of the rotating bracket is located below the potentiometer.

The potentiometer is provided with multiple first potential gears, and the top surface of the rotating bracket is provided with a first elastic slice for being abutted against one of the multiple potential gears.

The temperature control adjustment valve is rotated and adjusted to drive the rotating bracket to rotate, so that the first elastic slice is abutted against different multiple first potential gears to realize an adjustment of electric potential of the potentiometer.

Appropriately, a first spacing assembly is defined between the temperature control adjustment valve and the rotating bracket, the first spacing assembly is applied for limiting positions of the temperature control adjustment valve and the rotating bracket and prompting a user with a completion of an adjustment of the potentiometer, when the first elastic slice is abutted against one of the multiple first potential gears on the potentiometer.

Appropriately, the first spacing assembly comprises a first limiting bracket, a first elastic limiting slice and first balls;

The first limiting bracket is provided with a first slot for inserting the first elastic limiting slice, and multiple first openings for holding the first balls; the rotating bracket is provided with multiple first ball slots for being abutted against portions of the first balls protruding from the first openings.

When the rotating bracket is rotated, the first balls are removed from current first ball slots and fall into another first ball slots by elasticity of the first elastic limiting slice to produce a sound, the sound represents a completion of a potential gear adjustment of the potentiometer.

Appropriately, multiple fixed columns are defined on an end surface of the limiting bracket facing to the potentiometer; multiple first fixed grooves are defined on the potentiometer at positions corresponding to the multiple fixed columns; multiple first fixed holes are defined on the second connection base at positions corresponding to the multiple fixed columns;

The multiple fixed columns pass through the multiple first fixed grooves and the multiple first fixed holes correspondingly to fix the potentiometer and the limiting bracket on the second connection base by an interference fit.

Appropriately, the potentiometer is provided with multiple second potential gears, and an end surface of the temperature control adjustment valve facing to the potentiometer is provided with a second elastic slice for being abutted against one of the multiple second potential gears.

The temperature control adjustment valve is rotated and adjusted to make the second elastic slice to be abutted against different second potential gears of the potentiometer, so that the adjustment of electric potential of the potentiometer could be realized.

Appropriately, a second spacing assembly is defined between the temperature control adjustment valve and the second connection base for limiting positions of the temperature control adjustment valve and prompting a user with a completion of an adjustment of the potentiometer, when the second elastic slice is abutted against one of the multiple second potential gears on the potentiometer.

Appropriately, the second spacing assembly comprises a second limiting bracket, a second elastic limiting slice and second balls;

The second limiting bracket is provided with a second slot for inserting the second elastic limiting slice, and multiple second openings for holding the second balls; a sidewall surface of the temperature control adjustment valve facing to the second limiting bracket is provided with multiple second ball slots at the positions corresponding to the multiple second openings.

When the temperature control adjustment valve is rotated, the second balls are removed from current second ball slots and fall into another second ball slots by elasticity of the second elastic limiting slice to produce a sound, the sound represents a completion of a potential gear adjustment of the potentiometer.

Appropriately, the battery assembly comprises a second pin; the potentiometer is provided with second fixed grooves, and the second fixed holes are defined on the second connection base at the positions corresponding to the second fixed grooves. The second pin passes through the second fixed grooves and the second fixed holes to fix the potentiometer on the second connection base.

Appropriately, a temperature data information corresponding to the multiple second potential gears of the potentiometer is defined on an outer surface of the temperature control adjustment valve.

### Technical Effects of the Invention

### Technical Effects

The present application provides one or more technical solutions with at least the following technical effects or advantages.

In the present application, the battery assembly of the electronic cigarette comprises a battery case, a battery defined in the battery case and a connection assembly for connecting to the atomization assembly; the battery assembly further comprises: a first connection member, a second connection member, a potentiometer and a temperature control adjustment valve; the battery case comprises a first casing and a second casing, the battery is defined in the first casing, and the connection assembly is inserted in one end of the second casing, the end of the second casing is opposite to the first casing; the first connection member comprises a first connection base inserted in one end of the first casing, a first perforation is defined in a central part of the first connection base; the second connection member comprises a second connection base inserted in one end of the second casing, a second perforation is defined in the central part of the second connection base; a connection arm for connecting the first connection member and the second connection member is formed by an extension of the edge of the first perforation and/or the edge of the second perforation along a longitudinal direction of the battery case; the temperature control adjustment valve is movably sleeved on the connection arm, and can be rotated relative to the connection arm, the potentiometer is defined on one side on the temperature control adjustment valve which is opposite to the second casing, the potentiometer is electrically connected to the connection assembly; electric potential of the potentiometer can be adjusted by rotating the temperature control adjustment valve to adjust a current supplied by the battery to the atomization assembly, so as to achieve a temperature adjustment of a heating wire of the atomization assembly, the heating wire is applied for atomizing e-liquid. The present application can effectively solves a technical problem in the prior art that a battery assembly of the electronic cigarette is unable to adjust atomization temperature of a heating wire of an electronic cigarette, or a technical problem of an inconvenient operation caused by an unreasonable position of a temperature control knob of the battery assembly. The battery assembly of the present application could adjust the output power from the battery to the atomization assembly (which could be equivalent to adjust the temperature of the heating wire of the atomization assembly for atomizing the e-liquid), the battery has a simple and compact structure and is easy for a user to adjust the temperature.

### BRIEF DESCRIPTION OF THE DRAWINGS

The embodiments of the present application or the technical solution will be further described with reference to the accompanying drawings and embodiments in the following. Obviously, the following accompanying drawings are only parts of the present application and it is possible for one skilled in the art to obtain other accompanying drawings according to these without paying any inventive work.

FIG. 1 is a structural schematic view of an electronic cigarette provided in a preferred embodiment of the present application;

FIG. 2 is a structural schematic view of a battery assembly provided in a preferred embodiment of the present application;

FIG. 3 is a partial decomposition structural schematic view of a battery assembly provided in a preferred embodiment of the present application;

FIG. 4 is an overall structural schematic view of a potentiometer, a first spacing assembly and a temperature control adjustment valve of a battery assembly provided in a preferred embodiment of the present application;

FIG. 5 is a structural schematic view of a limiting bracket of a battery assembly provided in a preferred embodiment of the present application;

FIG. 6 is a structural schematic view of a rotating bracket of a battery assembly provided in a preferred embodiment of the present application;

FIG. 7 is a section structural schematic view of a potentiometer, a first spacing assembly and a temperature control adjustment valve of a battery assembly provided in a preferred embodiment of the present application;

FIG. 8 is a structural schematic view of a second connection base of a battery assembly provided in a preferred embodiment of the present application;

FIG. 9 is a structural schematic view of a second connection base and a potentiometer of another battery assembly provided in a preferred embodiment of the present application;

FIG. 10 is a section structural schematic view of a second connection base, a potentiometer, a second spacing assembly and a temperature control adjustment valve of another battery assembly provided in a preferred embodiment of the present application;

FIG. 11 is a structural schematic view of a temperature control adjustment valve of another battery assembly provided in a preferred embodiment of the present application;

FIG. 12 is a structural schematic view of a limiting bracket of another battery assembly provided in a preferred embodiment of the present application;

FIG. 13 is a schematic view of an external temperature data information of a battery assembly provided in a preferred embodiment of the present application.

### DETAILED DESCRIPTION OF THE PREFERRED EMBODIMENT

The embodiment of the present application provided a battery assembly to effectively solve a technical problem that a battery assembly of the electronic cigarette is unable to adjust atomization temperature of a heating wire of an electronic cigarette, or a technical problem of an inconvenient operation caused by an unreasonable position of a temperature control knob of the battery assembly. The battery assembly of the present application could adjust the output power from the battery to an atomization assembly (which could be equivalent to adjust the temperature of the heating wire of the atomization assembly for atomizing e-liquid), the battery has a simple and compact structure and is easy for a user to adjust the temperature.

The embodiment's technical solution of the present application is to solve the above technical problems. The general idea is as follows:

The embodiment of the present application provided a battery assembly for forming an electronic cigarette with a atomization assembly, the battery assembly of the electronic cigarette comprises a battery case, a battery defined in the battery case and a connection assembly for being connected to the atomization assembly; the battery assembly further comprises: a first connection member, a second connection member, a potentiometer and a temperature control adjustment valve; the battery case comprises a first casing and a second casing, the battery is defined in the first casing, and the connection assembly is inserted in one end of the second casing, the end of the second casing is opposite to the first casing; the first connection member comprises a first connection base inserted in one end of the first casing, a first perforation is defined in a central part of the first connection base; the second connection member comprises a second connection base inserted in one end of the second casing, a second perforation is defined in the central part of the second connection base; a connection arm for connecting the first connection member and the second connection member is formed by an extension of the edge of the first perforation and/or the edge of the second perforation along a longitudinal direction of the battery case; the temperature control adjustment valve is movably sleeved on the connection arm, and can be rotated relative to the connection arm, the potentiometer is defined on one side on the temperature control adjustment valve which is opposite to the second casing, the potentiometer is electrically connected to the connection assembly; electric potential of the potentiometer can be adjusted by rotating the temperature control adjustment valve to adjust a current supplied from the battery to the atomization assembly, so as to achieve a temperature adjustment of a heating wire of the atomization assembly, the heating wire is applied for atomizing e-liquid.

A temperature control adjustment assembly (including a first connection member, a second connection member, a potentiometer and a temperature control adjustment valve) is defined between the battery of the battery assembly and the connection assembly which is applied for being connected to the atomization assembly; the output power from the battery to the atomization assembly could be adjusted by adjusting the temperature control adjustment valve to adjust the electric potential of the potentiometer. The present application can effectively solves a technical problem the prior art that a battery assembly of an electronic cigarette is unable to adjust the atomization temperature of a heating wire of the electronic cigarette, or a technical problem of an inconvenient operation caused by an unreasonable position of a temperature control knob of a battery assembly. The battery assembly of the present application could adjust the output power from the battery to the atomization assembly (which could be equivalent to adjust the temperature of the heating wire of the atomization assembly that using for atomizing the e-liquid), the battery has a simple and compact structure and is easy for a user to adjust the temperature.

To make the technical feature, objective and effect of the present application be understood more clearly, now the specific implementation of the present application is described in detail with reference to the accompanying drawings and embodiments. It should be understood that the embodiments of the application and the specific features of the embodiments are detailed instructions for the technical scheme of the application instead of limiting the technical scheme for this application. In the absence of confliction, the embodiments of the application and the technical features in the embodiments can be combined.

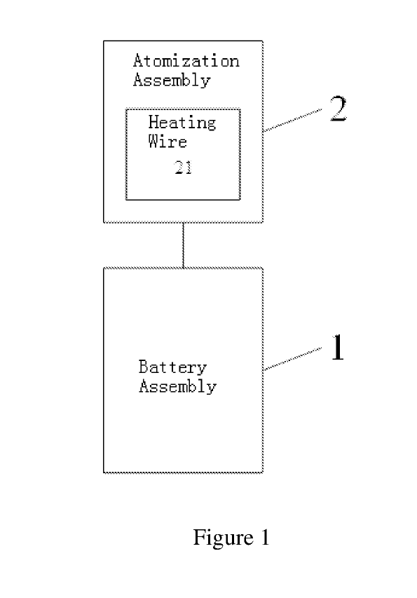

As shown in FIG. 1, a preferred embodiment of the present application had provided a battery assembly 1 which is used for forming electronic cigarette with an atomization assembly 2.

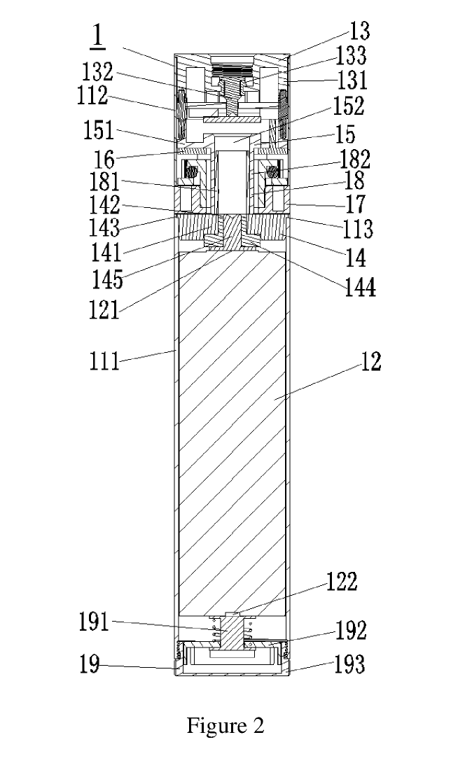

As shown in FIG. 1 and FIG. 2, the battery assembly 1 comprises a battery case 11, a battery 12 defined in the battery case 11, and a connection assembly 13 for being connected to an atomization assembly 2. The battery assembly 1 further comprises: a first connection member 14, a second connection member 15, a potentiometer 16, and a temperature control adjustment valve 17.

The battery case 11 comprises a first casing 111 and a second casing 112, the battery 12 is defined in the first casing 111, and the connection assembly is 13 inserted in one end of the second casing 112, the end of the second casing is opposite to the first casing 111; the first connection member 14 comprises a first connection base 141 inserted in one end of the first casing 111, a first perforation 142 is defined in the central part of the first connection base 141; the second connection member 15 comprises a second connection base 151 inserted in one end of the second casing 112, a second perforation 152 is defined in the central part of the second connection base 151; a connection arm 18 for connecting the first connection member 14 and the second connection member 15 is formed by an extension of the edge of the first perforation 142 and/or the edge of the second perforation 152 along a longitudinal direction of the battery case.

The temperature control adjustment valve 17 is movably sleeved on a connection arm 18 and is rotatable relative to the connection arm 18. The potentiometer 16 defined on one side of the temperature control adjustment valve 17 which is opposite to the second casing 112. The potentiometer 16 is electrically connected to the connection assembly 13. The temperature control adjustment valve 17 is rotationally adjusted to adjust the electric potential of the potentiometer 16, so as to adjust a current provided by the battery 12 to the atomization assembly 2, thereby realizing a temperature adjustment on a heating wire 21 in the atomization assembly 2, the heating wire 21 is applied for atomizing the e-liquid.

As shown in FIG. 2, in a specific implementation process, the connection arm 18 comprises a first extension tube 181 formed by an extension of the edge of the first perforation 142 along the longitudinal extension of the battery case 11 and a second extension tube 182 formed by an extension of the edge of the second perforation 152 along the longitudinal extension of the battery case 11; the second extension tube 182 sleeves on the first extension tube 181, and the temperature control adjustment valve 17 is movably fitted on the second extension tube 182.

In a specific implementation process, the connection arm 18 could only comprise the first extension tube 181 formed by an extension of the edge of the first perforation 142 along the longitudinal extension of the battery case 11, in this case, the first extension tube 181 extends into the second perforation 152; or the connection arm 18 could only comprise the second extension tube 182 formed by an extension of the edge of the second perforation 152 along the longitudinal extension of the battery case 11, in this case, the second extension tube 182 extends into the first perforation 142.

Furthermore, as shown in FIG. 2, an outer circumference surface of one end of the first connection base 141 is extended outward to form a ring-shaped spacing ring 143, the first connection base 141 is fixedly coupled with the first casing 111 by an interference fit, and the spacing ring 143 is abutted against an end surface of the first casing 111 to block the first connection base 141 from moving to the direction of the battery 12. Moreover, a ring-shape limiting groove 113 is defined on one end of the first casing 111, the spacing ring 143 is inserted in the limiting groove 113.

As shown in the FIG. 2, in a specific implementation process, the battery 12 comprises a first electrode 121 and a second electrode 122; a first insulating ring 144 is inserted in the first perforation 142 and a first electrode column 145 is inserted in the insulating ring 144, the first electrode column 145 is abutted against the first electrode 121 and electrically connected to the connection assembly 13 through a wire; one end of the first casing 111 is detachably connected to a battery cover assembly 19, the end of the first casing 111 is opposite to the first connection member 14, the battery cover assembly 19 is elastically abutted against the second electrode 122, so that the second electrode 122 is electrically connected to the connection assembly 13 by the battery cover assembly 19, the first casing 111, the first connection member 14 and the second connection member 15.

Therein the battery cover assembly 19 comprises an elastic electrode column 191, a battery cover bracket 192 and a battery cover 193. A through-hole is defined in the middle of an end surface of the battery cover bracket 192, the elastic electrode column 191 is arranged in the through-hole of which one end is fixedly connected to the battery cover bracket 192 and the other end is elastically abutted against the second electrode 122 of the battery 12. In a specific implementation process, the elastic electrode column 191 could be a spring element, and also could be an electrode column fitted with an external spring element; the battery cover 193 is connected to one end of the first casing 111 which is opposite to the first connection member 14 by a threaded connection.

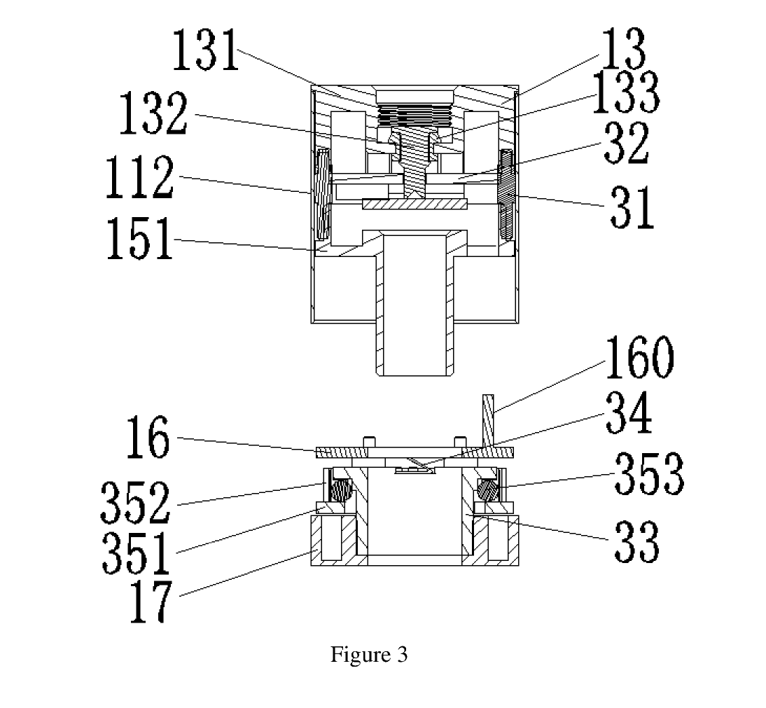

In a specific implementation process, as shown in FIG. 2 and FIG. 3, the connection assembly 13 comprises a hollow connector 131 and a second electrode column 132 defined in a hollow part of the connector 131; the second electrode column 132 is connected to a wall of the hollow part of the connector 131 by the second insulating ring 133 and is applied for supplying power to the atomization assembly 2 when the battery assembly 1 is connected to the atomization assembly 2. The inner side of the connector 131 is provided with an inner thread for a connection with the atomization assembly 2 which is provided with an outer thread to match with the inner thread. One end of the second connection base 151 which is opposite to the first connection base 141 is fixed to the connector 131 by a first pin 31.

Specifically, as shown in FIG. 2 and FIG. 3, a PCBA board 32 is defined between the connector 131 and the second connection base 151, the PCBA board 32 is electrically connected to the potentiometer 16 by an electric wire 160, and the PCBA board 32 is provided with a control circuit which is used for controlling the output power of the battery assembly according to the electric potential of the potentiometer 16; the PCBA board 32 and the second connection base 151 are fixed on the connector 131 together by the first pin 31, a through-hole is defined in the middle part of the PCBA board 32 and the second electrode column 132 is arranged in the through-hole, as shown in FIG. 2, it is connected to the first electrode 121 of battery 12, and supplies power to the atomization assembly 2 when the battery assembly 1 is connected with the atomization assembly 2.

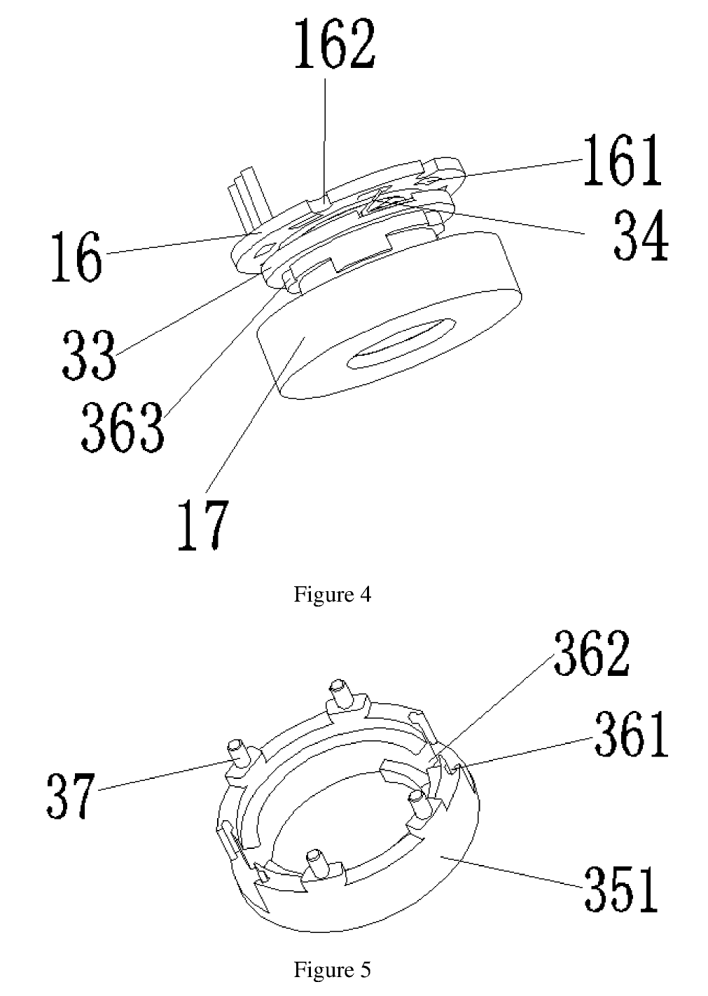

In the first embodiment of the present application, as shown in FIG. 3, FIG. 4 and FIG. 7, a rotating bracket 33 is interference fitted between the temperature control adjustment valve 17 and the second connection base 151 along a longitudinal direction of the battery assembly 1, the top surface of the rotating bracket 33 is located below the potentiometer 16.

The potentiometer 16 is provided with multiple first potential gears 161, and the top surface of the rotating bracket 33 is provided with a first elastic slice 34 for being abutted against one of the multiple first potential gears 161.

The temperature control adjustment valve 17 is rotated and adjusted to drive the rotating bracket 33 to rotate, so that the first elastic slice 34 is abutted against different first potential gears 161 to realize an adjustment of the electric potential of the potentiometer 16.

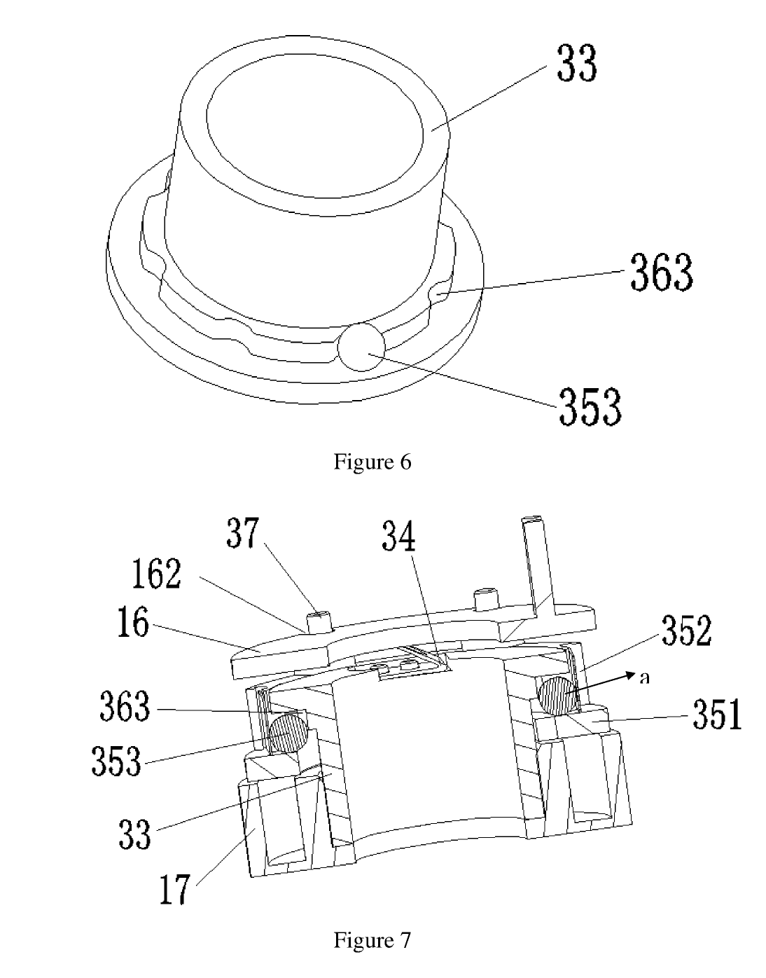

Furthermore, as shown in FIG. 3, FIG. 4 and FIG. 7, a first spacing assembly is defined between the temperature control adjustment valve 17 and the rotating bracket 33, the first spacing assembly is used for limiting positions of the temperature control adjustment valve 17 and the rotating bracket 33 and prompting a user with a completion of an adjustment of the potentiometer 16, when the first elastic slice 34 is abutted against one of the multiple first potential gears 161 on the potentiometer 16. Specifically, the first spacing assembly comprises a first limiting bracket 351, a first elastic limiting slice 352 and first balls 353; then, as shown in the FIG. 5 and FIG. 7, the first limiting bracket 351 is provided with a first slot for inserting the first elastic limiting slice 352, and multiple first openings 362 for holding the first balls 353; as shown in FIGS. 3-6, the rotating bracket 33 is provided with multiple first ball slots 363 for being abutted against portions of the first balls protruding from the first openings 362.

As shown in FIG. 7, when the rotating bracket 33 is rotated, the first balls 353 are removed from the current first ball slots and fall into another first ball slots by elasticity of the first elastic limiting slice 352 to produce a sound, the sound represents a completion of a potential gear adjustment of the potentiometer 16. Specifically, when the rotating bracket 33 is not rotated, the first elastic limiting slice 352 is in its vertical state, when the rotating bracket 33 is rotated, the first balls 353 are removed from the current first ball slots outwards (shown by an arrow a in FIG. 7), the first elastic limiting slice 352 is pressed into a bending state until the first balls 353 fall into another first ball slots during rotation and produce the sound.

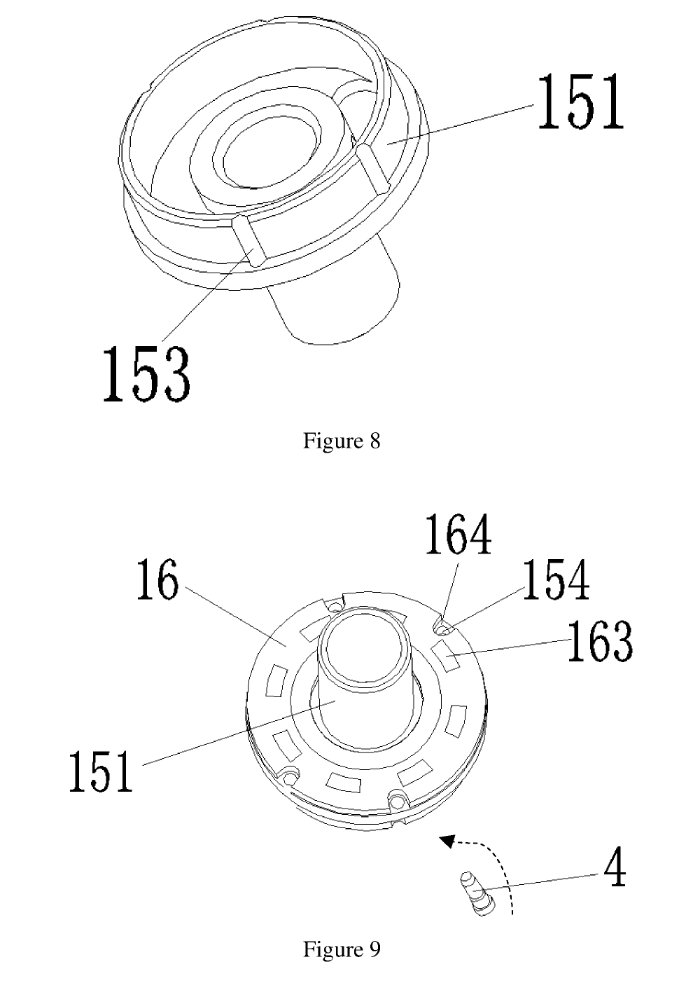

Further, as shown in FIG. 5 and FIG. 7, multiple fixed columns 37 are defined on one end of the first limiting bracket 351 facing to the potentiometer 16; as shown in FIG. 4 and FIG. 7, multiple first fixed grooves 162 are defined on the potentiometer 16 at positions corresponding to the multiple fixed columns 37; as shown in FIG. 8, multiple first fixed holes 153 are defined the second connection base 151 at positions corresponding to the multiple fixed columns 37.

As shown in FIG. 5, FIG. 7 and FIG. 8, the multiple fixed columns 37 pass through the multiple first fixed grooves 162 and multiple first fixed holes 153 correspondingly to fix the potentiometer 16 and the first limiting bracket 351 on the second connection base 151 by an interference fit.

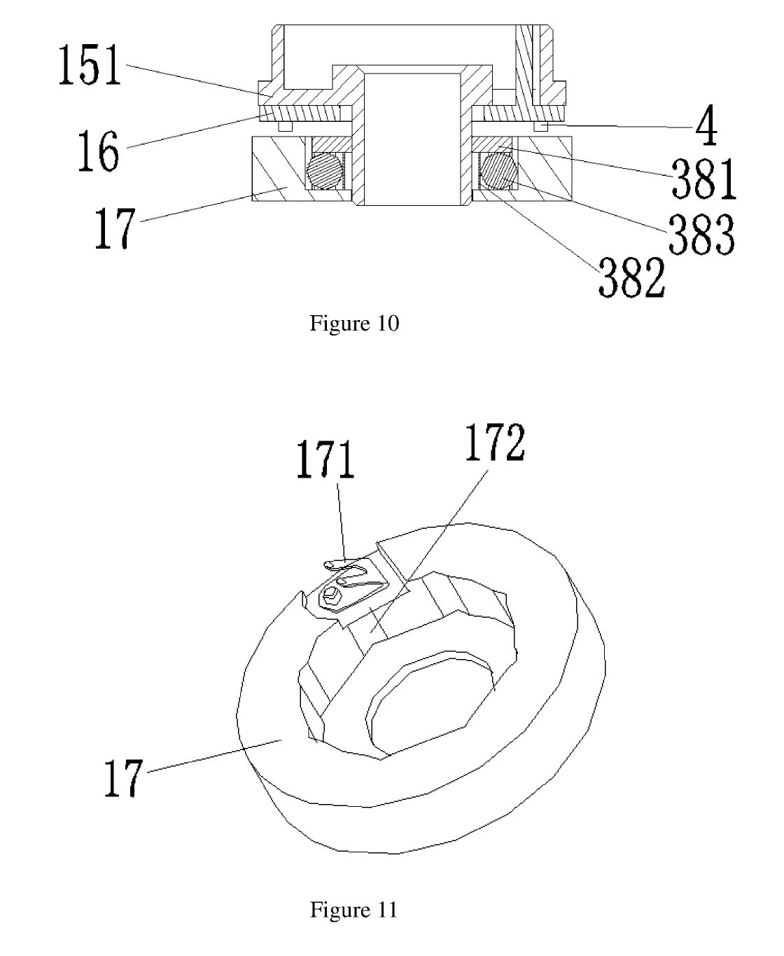

In the second embodiment of the present application, the rotating bracket 33 has been removed on the basis of the first embodiment, and other structures are adjusted to simplify the structure of first spacing assembly to facilitate assembly and save materials. As shown in FIGS. 9-11, the potentiometer 16 is provided with multiple second potential gears 163, and an end surface of the temperature control adjustment valve 17 facing to the potentiometer 16 is provided with a second elastic slice 171 which is used to be abutted against one of the multiple second potential gears 163; a second spacing assembly is defined between the temperature control adjustment valve 17 and the second connection base 151 for limiting positions of the temperature control adjustment valve 17 and prompting a user with a completion of an adjustment of the potentiometer 16, when the second elastic slice 171 is abutted against one of the multiple second potential gears 163 on the potentiometer 16.

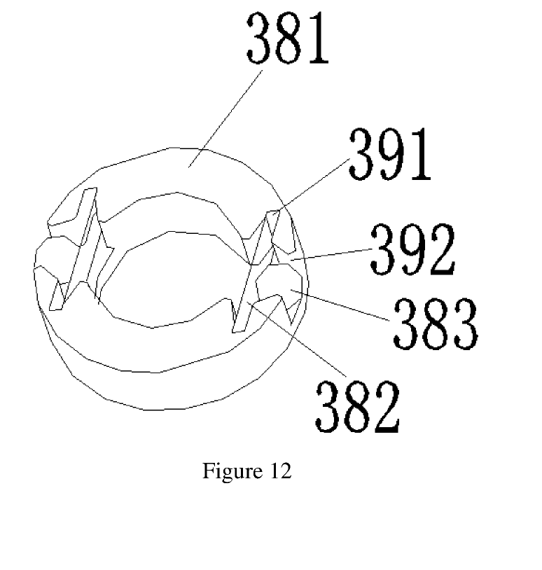

Specifically, as shown in FIGS. 10-12, the second spacing assembly comprises a second limiting bracket 381, a second elastic limiting slice 382 and second balls 383; the second limiting bracket 381 is provided with a second slot 391 for inserting the second elastic limiting slice 382, and multiple second openings 392 for holding the second balls 383; a sidewall surface of the temperature control adjustment valve 17 facing to the second limiting bracket 381 is provided with multiple second ball slots 172 at the positions corresponding to the multiple second openings 392; the temperature control adjustment valve 17 could be rotated and adjusted to make the second elastic slice 171 to be abutted against different second potential gears of the potentiometer 16, so as to realize an adjustment of electric potential of the potentiometer 16. When the temperature control adjustment valve 17 is rotated, the second balls 383 are removed from the current second ball slots and fall into another second ball slots by elasticity of the second elastic limiting slice 382 to produce a sound, the sound represents a completion of a potential gear adjustment of the potentiometer 16. Specifically, the method for rotating the temperature control adjustment valve 17 to make the second balls 383 be removed from the current second ball slots and fall into another second ball slots is the same as that of the first embodiment.

In a specific implementation process, as shown in FIG. 9 and FIG. 10, the battery assembly 1 comprises a second pin 4; the potentiometer 16 is provided with second fixed grooves 164 and the second fixed holes 154 are defined on the second connection base 151 at the positions corresponding to the second fixed grooves 164. The second pin 4 passes through the second fixed grooves 164 and the second fixed holes 154 to fix the potentiometer 16 on the second connection base 151.

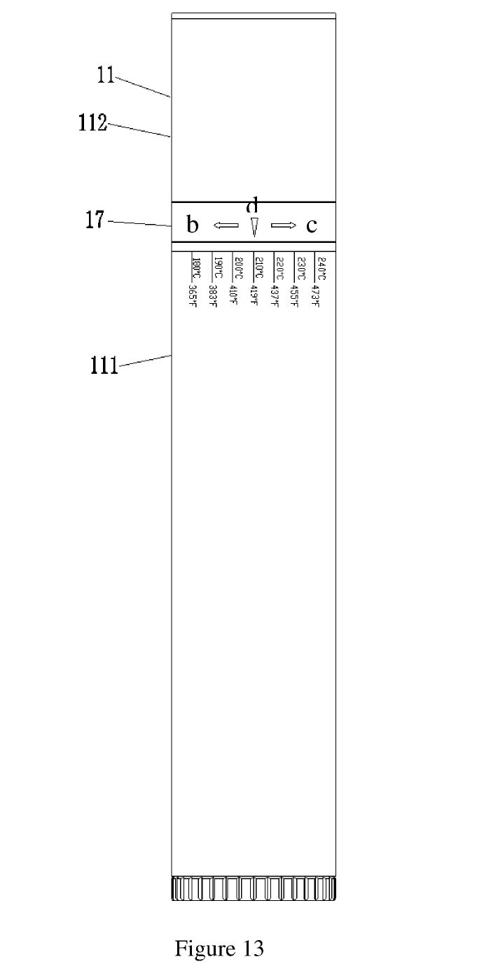

In addition, In a specific implementation process, for convenience of users to learn the temperature of the heating wire 21 under a current gear when adjusting gears of the potentiometer 16, a temperature data information corresponding to the multiple second potential gears of the potentiometer 16 are defined on an outer surface of the temperature control adjustment valve 17. As shown in FIG. 13, an external surface of the temperature control adjustment valve 17 is provided with indication marks b, c for indicating rotation directions, as well as a location mark d for indicating the temperature of the current gear; a surface of the battery case 11 is provided with a Celsius degree information corresponding to a second potential gear of the potentiometer 16, as well as a Fahrenheit degree information corresponding to the Celsius degree information, users could adjust the temperature control adjustment valve 7 according to actual requirements.

To sum up, the battery assembly of the present application could adjust the output power from the battery to the atomization assembly (which could be equivalent to adjust the temperature of the heating wire of the atomization assembly for atomizing the e-liquid), the battery has a simple and compact structure and is easy for a user to adjust the temperature.

Although preferred embodiments of the application have been described, one skilled in the art may make additional changes and modifications to these embodiments once they have been informed of basic creative concepts. Therefore, the claims are intended to be construed to include preferred embodiments and all changes and modifications falling within the scope of the application.

Obviously, one skilled in the art can make various modifications and variations to the application without being separated from the spirit and scope of the invention. If these modifications and variants of the present application fall within the scope of the claims and equivalent technologies of the present application, the present application also intends to include such modifications and variants.

1. A battery assembly for forming an electronic cigarette with an atomization assembly; the battery assembly comprises a battery case, a battery defined in the battery case and a connection assembly for being connected to the atomization assembly; wherein the battery assembly further comprises: a first connection member, a second connection member, a potentiometer and a temperature control adjustment valve;
wherein the battery case comprises a first casing and a second casing, the battery is defined in the first casing, and the connection assembly is inserted in one end of the second casing, the end of the second casing is opposite to the first casing; the first connection member comprises a first connection base inserted in one end of the first casing, a first perforation is defined in a central part of the first connection base; the second connection member comprises a second connection base inserted in one end of the second casing, a second perforation is defined in a central part of the second connection base; a connection arm for connecting the first connection member and the second connection member is formed by an extension of an edge of the first perforation and/or an edge of the second perforation along a longitudinal direction of the battery case; and
wherein the temperature control adjustment valve is movably sleeved on the connection arm, and can be rotated relative to the connection arm, the potentiometer is defined on one side of the temperature control adjustment valve the side of the temperature control adjustment valve is opposite to the second casing, the potentiometer is electrically connected to the connection assembly; electric potential of the potentiometer can be adjusted by rotating the temperature control adjustment valve to adjust a current supplied from the battery to the atomization assembly, so as to achieve a temperature adjustment of a heating wire in the atomization assembly, the heating wire is applied for atomizing e-liquid.

2. The battery assembly according to claim 1, wherein the connection arm comprises a first extension tube formed by the extension of the edge of the first perforation along the longitudinal direction of the battery case and a second extension tube formed by the extension of the edge of the second perforation along the longitudinal direction of the battery case; the second extension tube sleeves on the first extension tube, and the temperature control adjustment valve is movably sleeved on the second extension tube.

3. The battery assembly according to claim 2, wherein an outer circumference surface of one end of the first connection base is extended outward to form a spacing ring which is in a ring shape, the first connection base is fixedly coupled with the first casing by an interference fit, and the spacing ring is abutted against an end surface of the first casing to block the first connection base from moving to a direction of the battery.

4. The battery assembly according to claim 3, wherein a limiting groove which is in a ring shape is defined on an end surface of the first casing, the spacing ring is embedded in the limiting groove.

5. The battery assembly according to claim 2, wherein the battery comprises a first electrode and a second electrode; a first insulating ring is inserted in the first perforation; a first electrode column is inserted in the first insulating ring, the first electrode column is abutted against the first electrode and electrically connected to the connection assembly by a wire; one end of the first casing is detachably connected to a battery cover assembly, the end of the first casing is opposite to the first connection member, the battery cover assembly is elastically abutted against the second electrode, so that the second electrode is electrically connected to the connection assembly by the battery cover assembly, the first casing, the first connection member and the second connection member.

6. The battery assembly according to claim 1, wherein the connection assembly comprises a hollow connector and a second electrode column defined in a hollow part of the connector; the second electrode column is abutted against a wall of the hollow part of the connector by a second insulating ring and is applied for supplying power to the atomization assembly when the battery assembly is connected to the atomization assembly.

7. The battery assembly according to claim 6, wherein one end of the second connection base is fixed to the connector by a first pin, the end of the second connection base is opposite to the first connection base.

8. The battery assembly according to claim 1, wherein a rotating bracket is interference fitted between the temperature control adjustment valve and the second connection base along a longitudinal direction of the battery assembly, a top surface of the rotating bracket is located below the potentiometer;
wherein the potentiometer is provided with multiple first potential gears, and the top surface of the rotating bracket is provided with a first elastic slice for being abutted against one of the multiple first potential gears; and
wherein the temperature control adjustment valve is rotated and adjusted to drive the rotating bracket to rotate, so that the first elastic slice is abutted against different first potential gears to realize an adjustment of electric potential of the potentiometer.

9. The battery assembly according to claim 8, wherein a first spacing assembly is defined between the temperature control adjustment valve and the rotating bracket, the first spacing assembly is applied for limiting positions of the temperature control adjustment valve and the rotating bracket and prompting a user with a completion of an adjustment of the potentiometer, when the first elastic slice is abutted against one of the multiple first potential gears on the potentiometer.

10. The battery assembly according to claim 9, wherein the first spacing assembly comprises a first limiting bracket, a first elastic limiting slice and first balls;
wherein the first limiting bracket is provided with a first slot for inserting the first elastic limiting slice, and multiple first openings for holding the first balls; the rotating bracket is provided with multiple first ball slots for being abutted against portions of the first balls protruding from the first openings; and
wherein the first balls are removed from current first ball slots and fall into another first ball slots by elasticity of the first elastic limiting slice to produce a sound, when the rotating bracket is rotated; the sound represents a completion of a potential gear adjustment of the potentiometer.

11. The battery assembly according to claim 10, wherein multiple fixed columns are defined on an end surface of the first limiting bracket facing to the potentiometer; multiple first fixed grooves are defined on the potentiometer at positions corresponding to the multiple fixed columns; multiple first fixed holes are defined on the second connection base at positions corresponding to the multiple fixed columns; and
wherein the multiple fixed columns pass through the multiple first fixed grooves and the multiple first fixed holes correspondingly to fix the potentiometer and the limiting bracket on the second connection base by an interference fit.

12. The battery assembly according to claim 1, wherein the potentiometer is provided with multiple second potential gears, and an end surface of the temperature control adjustment valve facing to the potentiometer is provided with a second elastic slice for being abutted against one of the multiple second potential gears; and
wherein the temperature control adjustment valve is rotated and adjusted to make the second elastic slice to be abutted against different second potential gears of the potentiometer, so that an adjustment of the electric potential of potentiometer could be realized.

13. The battery assembly according to claim 12, wherein a second spacing assembly is defined between the temperature control adjustment valve and the second connection base for limiting positions of the temperature control adjustment valve and prompting a user with a completion of an adjustment of the potentiometer, when the second elastic slice is abutted against one of the multiple second potential gears on the potentiometer.

14. The battery assembly according to claim 13, wherein the second spacing assembly comprises a second limiting bracket, a second elastic limiting slice and second balls;
wherein the second limiting bracket is provided with a second slot for inserting the second elastic limiting slice, and multiple second openings for holding the second balls; a sidewall surface of the temperature control adjustment valve facing to the second limiting bracket is provided with multiple second ball slots at the positions corresponding to the multiple second openings; and
wherein the second balls are removed from current second ball slots and fall into another second ball slots by elasticity of the second elastic limiting slice to produce a sound, when the temperature control adjustment valve is rotated; the sound represents a completion of a potential gear adjustment of the potentiometer.

15. The battery assembly according to claim 14, wherein the battery assembly comprises a second pin; the potentiometer is provided with second fixed grooves, and the second fixed holes are defined on the second connection base at the positions corresponding to the second fixed grooves, the second pin passes through the second fixed grooves and the second fixed holes to fix the potentiometer on the second connection base.

16. The battery assembly according to claim 1, wherein a temperature data information corresponding to the multiple second potential gears of the potentiometer is defined on an outer surface of the temperature control adjustment valve.
